(19) United States
(12) Patent Application Publication
(10) Pub. No.: US 2008/0002936 A1
(43) Pub. Date: Jan. 3, 2008

(54) 3-DIMENSIONAL OPTICAL FIBER CIRCUITRY ELEMENT AND METHOD OF MAKING THE SAME

(75) Inventor: Maurice Sun, Naperville, IL (US)

Correspondence Address: MOLEX INCORPORATED, 2222 WELLINGTON COURT, LISLE, IL, 60532, US

(73) Assignee: Molex Incorporated, Lisle, IL (US)

(21) Appl. No.: 11/531,458

(22) Filed: Sep. 13, 2006

Related U.S. Application Data
(60) Provisional application No. 60/817,492, filed on Jun. 29, 2006.

(51) Int. Cl. G02B 6/44; G02B 6/26; G02B 6/42

(52) U.S. Cl. 385/114; 385/15; 385/31; 385/39; 385/43

(57) ABSTRACT

An optical circuit device providing a system for redistributing a series of optical ribbons through the device to a predefined output configuration. The optical circuitry device utilizes a plurality of stacked substrates to reconfigure the input optical ribbons to a specific output pattern. The optical member includes an input section and an output section including a plurality of vertically stacked substrates that mix or redistribute the optical fibers from the input section to the output section.

### FIELD

This invention generally relates to three dimensional optical circuits, and more particularly, to a three dimensional optical circuit assembly comprising a layered optical redistribution member and method of making the same.

### BACKGROUND

Optical fiber networks are becoming increasingly common in modern telecommunications systems, high speed routers, computer systems and other systems for managing large volumes of data. Optical fiber networks typically include a large number of optical fibers that are routed over relatively long distances. In order to increase transmission speeds and efficiencies relative to the propagation of conventional electrical signals there is the need to route individual optical fibers between various connection points throughout the system creating an optical circuit. FIGS. 1 to 3 show typical systems that accomplishing this type of routing.

One of the more common ways of producing this optical circuit in use today is referred to as an optical shuffle, as illustrated in FIG. 2. The optical shuffle generally includes a series of input optical ribbons that include multiple individual optical fibers, a shuffle zone and a series of similar output optical ribbons. This process involves weaving the individual optical fibers by hand through the shuffle zone and create the desired output optical fiber configuration. This process is time consuming and costly and due to its complexity, can be prone to errors.

An alternative to the optical shuffle is an optical manifold. The optical manifold comprises a cast or layer generated structure providing a predetermined optical fiber redistribution configuration. The structure is typically generated by an “SLA” process in which a liquid polymer is laser sintered, layer on top of layer, until the structure is complete as best shown in FIG. 3. This three dimension array is then used a guide for the optical fibers. A fiber is inserted into an input channel an is the routed to a predetermined output location. The output fibers are then grouped into a desired output ribbon.

Along similar lines to the manifold, a layered technique is sometimes preferred. In this instance, a substrate is provided, and layered upon the substrate is a series of inserts that generate a series of grooves upon the substrate. This technique is repeated until a desired number of layers are produced. Similar to the cast or laser sintered manifold, the optical fibers are passed through the grooves between adjacent layers, from the input section to output section generated the desired optical fiber bundles.

Finally, flexible circuitry as depicted in FIG. 1 can also be used to redistribute the optic fibers. This method is automated but requires the optic fibers to be coupled to each end of the flexible circuit. These flexible circuits can be large and difficult to use in confined areas.

With respect to the listed techniques for producing the three dimensional optical circuit, all of the processes require a great deal of time and effort and can be quite costly.

### SUMMARY

In order to overcome the disadvantages inherent in previously known optical circuitry, there is provided a low cost and easily manufactured method of producing these types of three dimensional optical circuitry. Additionally, along with effectively producing this circuitry, there is also provided a method and system for making these optical components small in size so they may be used in environments with certain size restraints, in particular along the z-axes or stacking depth.

The present new and improved optical circuitry device provides a system for redistributing a series of optical ribbons through the device to a predefined output configuration. The optical circuitry device utilizes a plurality of stacked substrates to reconfigure the input optical ribbons to a specific output pattern. Connectors or other connection devices may be coupled to the input and output ends of the device to incorporate the device into existing systems and other fiber optic environments.

In an exemplary embodiment of the invention, a first set of optical ribbons is provided in which each optical ribbon contains multiple optical fibers therein. An optical member having an input section and an output section including a plurality of vertically stacked substrates is provided to mix or redistribute the optical fibers from the input section to the output section. The optical fibers are adhered to the substrates in a predetermined pattern so that the input optical fibers are regrouped to an appropriate output configuration according to prescribed requirements. The optical fibers extending from the output section are grouped according to any predetermined arrangement and are connected to an optical fiber device. The output sections can have any type of interface and may include, but is not limited to, optical fiber connectors, edge type connections or optical transceivers.

Other objects, features and advantages of the invention will be apparent from the following detailed description taken in connection with the accompanying drawings.

### BRIEF DESCRIPTION OF THE DRAWINGS

In the course of this detailed description, the reference will be frequently made to the attached drawings in which:

FIG. 1 is a top elevational view of a conventional optical mixing circuit utilizing a flexible circuit;

FIG. 2 is a top elevational view of a conventional optical shuffle;

FIG. 3 is a perspective view of a conventional optical manifold;

FIG. 4 is a perspective view of a first embodiment of the three dimensional optical mixing device according to the present invention;

FIG. 5 is an exploded view of the three dimensional optical mixing device of FIG.4;

FIG. 6 is a top elevational view of the first embodiment of the present invention illustrating a typical optical fiber arrangement on a substrate;

FIG. 7 is an end elevation view of the output section of the present invention of FIG. 6;

FIG. 8 is a detail view of one optical ribbon of the output section of FIG. 7;

FIG. 9 is a side elevational view of the output section of the present invention of FIG. 6;

FIG. 10 is a top elevational view of a second embodiment according to the present invention;

FIG. 11 is an end elevation of the second embodiment according to the present invention of FIG. 10;

FIG. 12 is a detail view of one optical ribbon of the output section of FIG. 11;

FIG. 13 is a side elevational view of the output section of the second embodiment according to the present invention of FIG. 10;

FIG. 14 is a top elevational view of a third embodiment according to the present invention;

FIG. 15 is an end elevation of the third embodiment according to the present invention of FIG. 14;

FIG. 16 is a side elevational view of the output section of the third embodiment according to the present invention of FIG. 14;

FIG. 17 is a top elevational view of a fourth embodiment according to the present invention;

FIG. 18 is an end elevation of the fourth embodiment according to the present invention of FIG. 17;

FIG. 19 is a side elevational view of the output section of the fourth embodiment according to the present invention of FIG. 17;

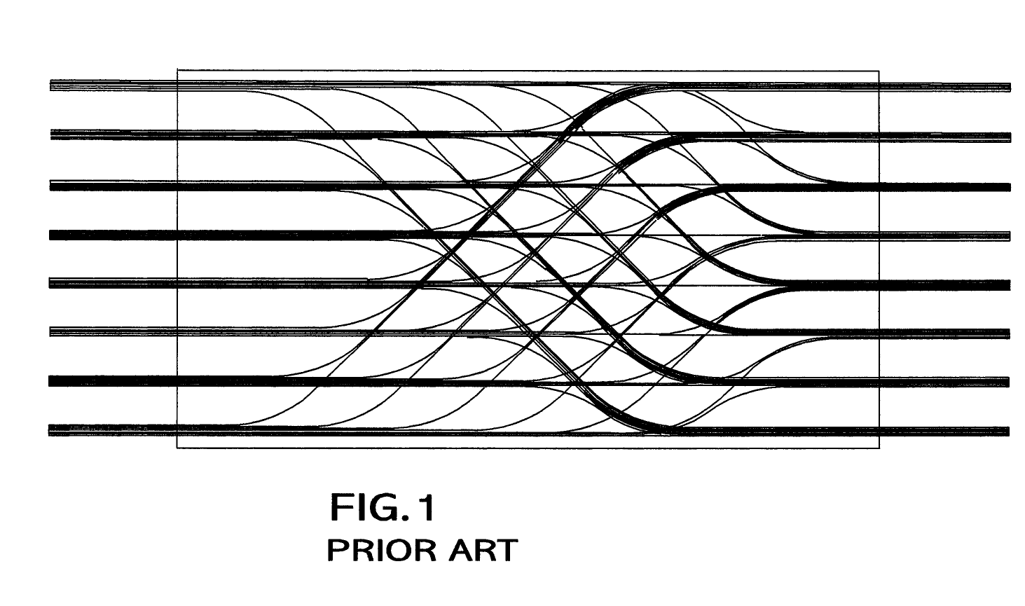

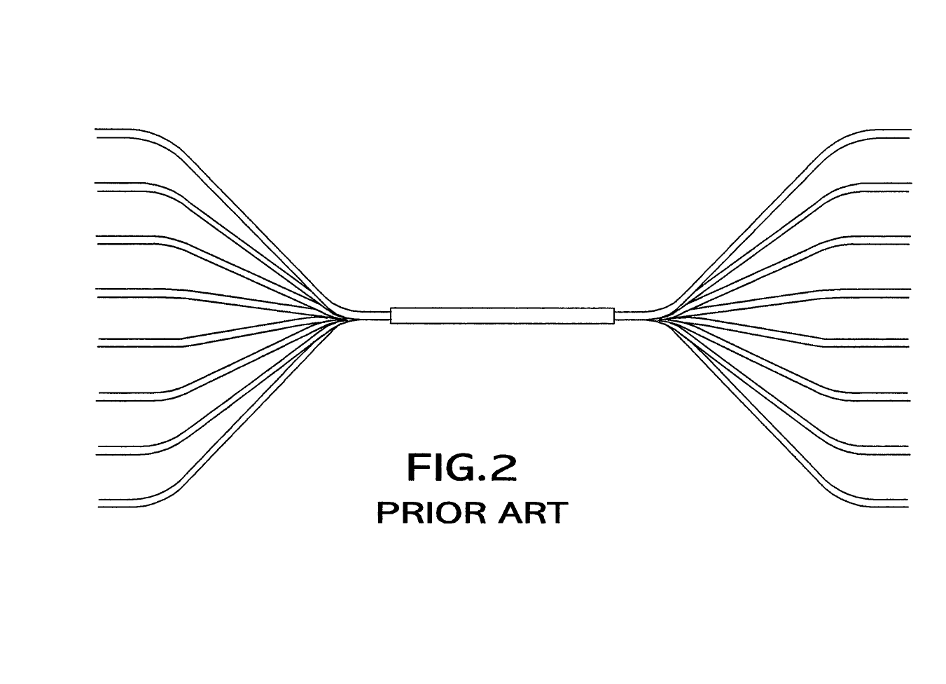

### DETAILED DESCRIPTION

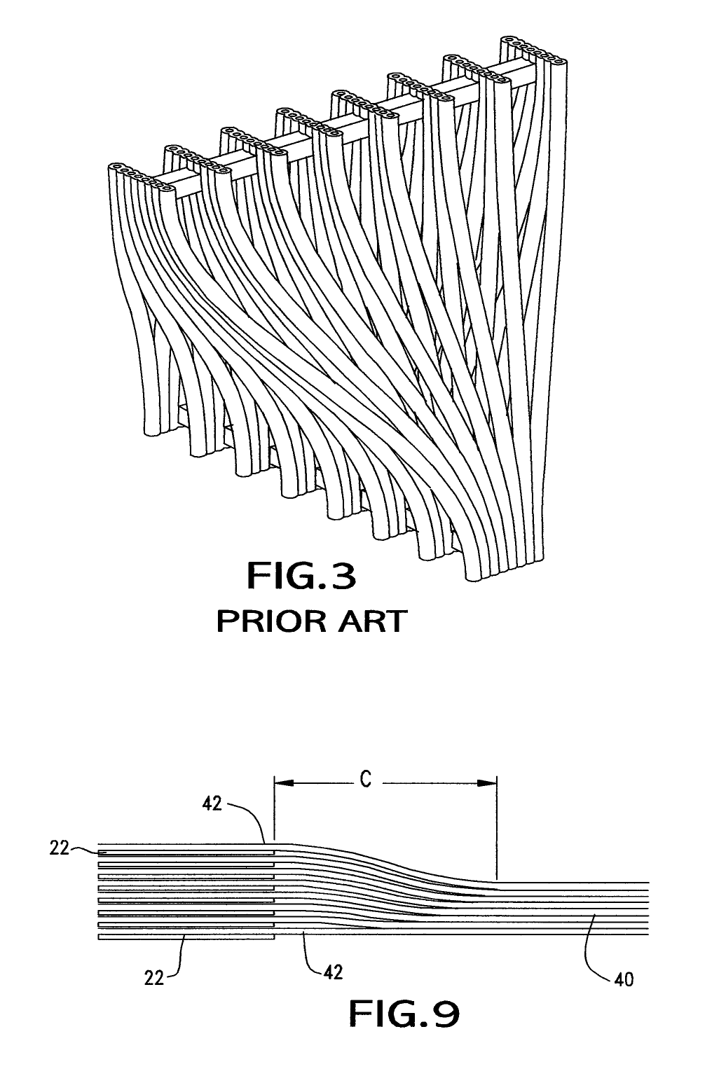

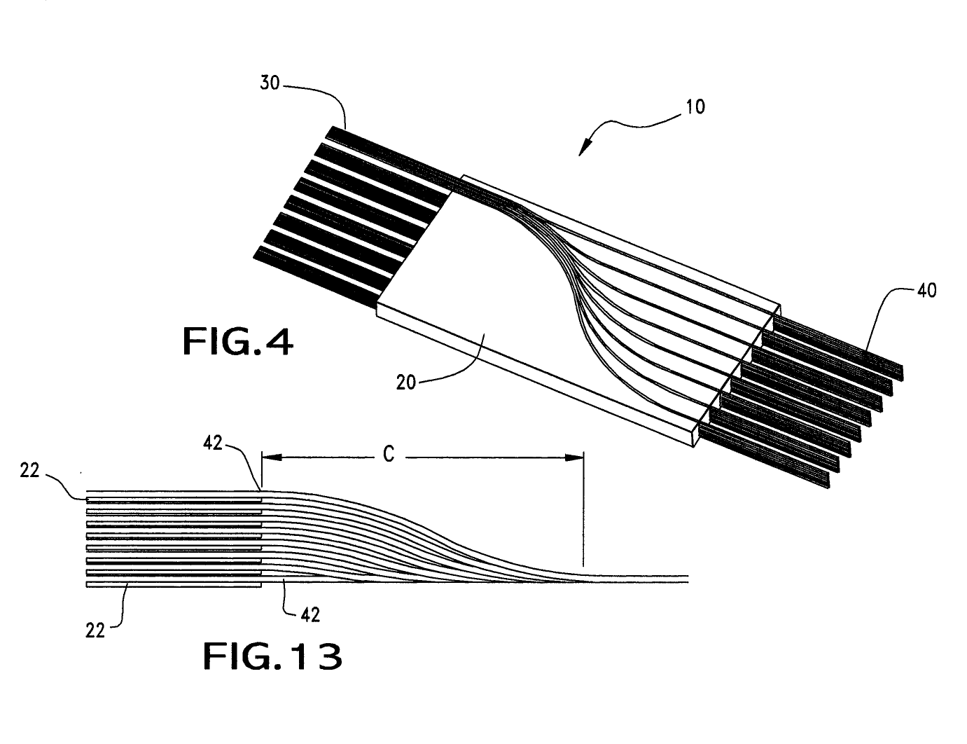

Referring to the drawings in greater detail, and first to FIGS. 4 to 8, the present optical circuitry device is embodied in an optical circuit assembly 10. The optical circuit assembly 10 includes an optical circuit 20 that takes an input optical ribbon 30 having multiple optical fibers 32. The device reorganizes the fibers 32 in a specific pattern and outputs an optical ribbon 40 having a different optical fiber arrangement within the output optical ribbon 40 than the input optical fibers 32 of the input optical ribbon 30.

FIG. 4 best shows the optical circuit assembly 10 in accordance with a first embodiment. The optical circuit assembly includes a plurality of input optical ribbons 30, an optical circuit 20 and a plurality of output optical ribbons 40. For illustrative purposes, the figures show an optical circuit assembly having eight input optical ribbons, an eight layer optical circuit and eight output optical ribbons. Each optical ribbon 30,40 includes eight individual optical fibers 32, 42. A conformal coating surrounds the optical fibers 32, 42 holding them together to create the optical ribbons 30, 40. These types of optical ribbons are generally flat and consist of the optical fibers lying in a side-by-side relationship. This type of arrangement is typically known as an 8×8 system or array. The exemplary embodiment is depicted as an 8×8 system but any number configuration can be used.

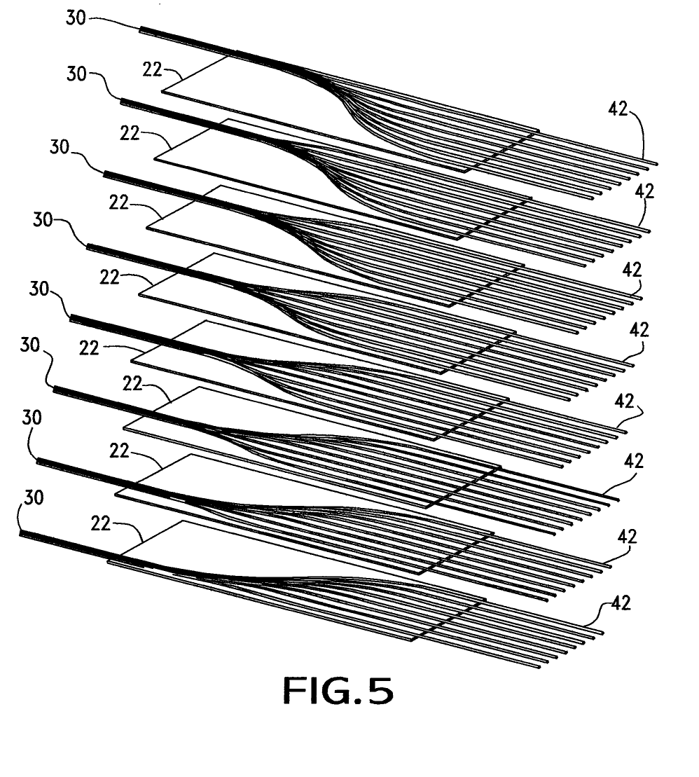

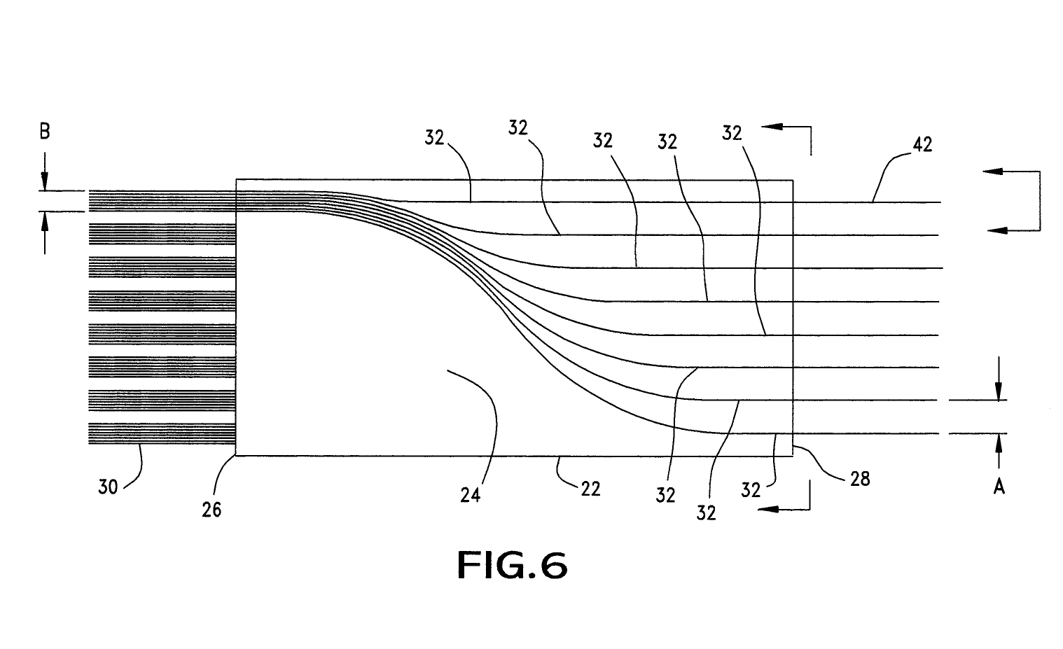

The optical circuit assembly 10 includes an optical circuit 20 positioned between the input optical ribbons 30 and the output optical ribbons 40. The optical circuit 20 includes a plurality of substrates 22 that are arranged in a stacked relationship. As best shown in FIGS. 5 and 6, in can be seen that in the exemplary embodiment there are a total of eight substrates 22. It is to be noted that fewer or greater substrates may be used as needed. Each substrate 22 includes an input section 26 and an output section 28 and a substrate surface 24 therebetween. Each substrate 22 includes an input ribbon 30 extending from the input section 26 of each substrate 22 and an output ribbon 40 extending from the output section 28 of each substrate 22.

As shown more particularly in FIG. 6, an individual substrate 22 includes input optical ribbons 30 extending from the input section 26 of the substrate 22. The input optical ribbon 30 extends from the substrate 22 in a generally parallel orientation to the substrate 22. The individual input optical fibers 32 are separated from the input optical ribbon 30 and are position on the substrate surface 24. The optical fibers 32 are adhered to the substrate surface 24 and are separated from the input optical ribbon 30 and spread out along the substrate surface 24 from the input section 26 of the substrate 22 to the output section 28 of the substrate 22.

It should be understood that the spacing between individual optical fibers 30 is dictated by either of the input optical ribbons 32 or the output optical ribbons 40. For example, in the exemplary embodiment shown in FIGS. 5 and 6, each of the input optical ribbons 30 is first separated and then position on a particular substrate 22 in a predetermined orientation. The spacing A between individual optical fibers 32 can only be equal to or greater than the width B of an optical ribbon 30. If the separation between the optical fibers 32 positioned on the substrate 22 tends to be less than the width of an optical ribbon 30 then the situation of fiber crossover will exist, that is, the optical ribbons 30 or a portion of the optical ribbons 30 will overlap each other. This will create undesired stress on the optical fibers 32 and increase the overall thickness of the optical circuit 20.

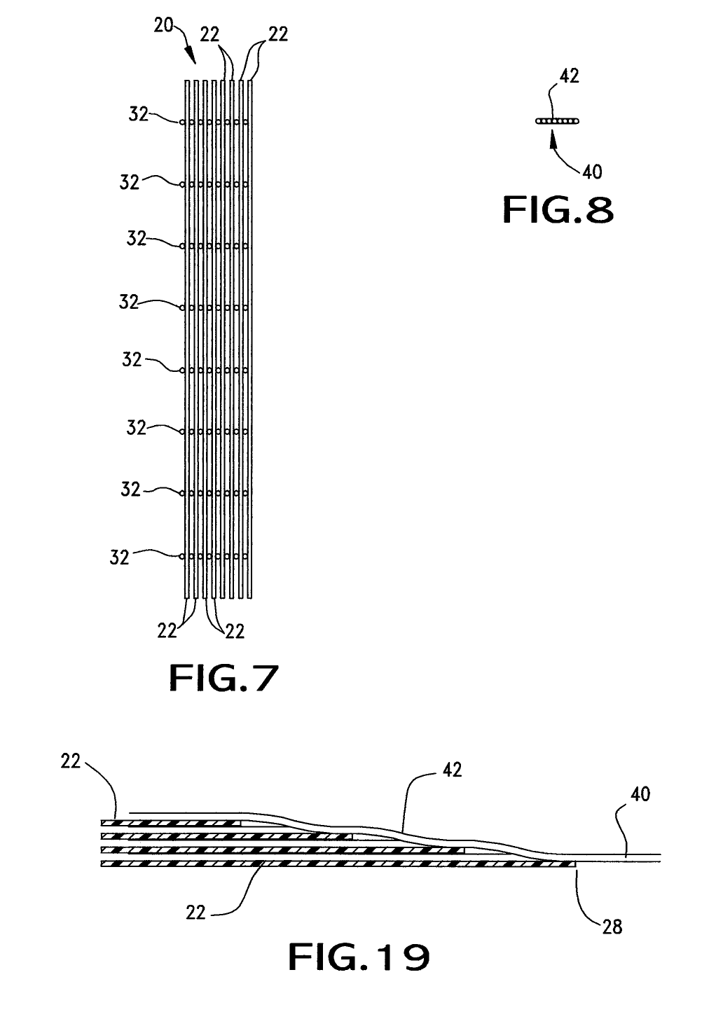

All of the output optical fibers 42 for each of the substrates 22 maintain the specific predetermined separation. The eight substrates 22 are stacked one on top of the other until they are all layered creating the optical circuit 20 of FIG. 4. FIG. 7 also shows an end view of the completed optical circuit 20. The optical circuit 20 consists of the eight substrates 22 stacked in a vertical relationship with the individual optical fibers 32 lying therebetween. In can be seen that the only space between the substrates is due to the thickness of the optical fibers.

In the present exemplary embodiment, as shown in FIGS. 8 and 9, the output optical fibers 42 extend from the output section 28 of the optical circuit 20 in a predetermined separation or arrangement. The output optical fibers 42 are now grouped in a vertical arrangement. All of the output optical fibers 42 lying vertically in the first column are combined to form an output optical ribbon 40. These optical fibers 42 also have a conformal coating applied to them to secure those optical fibers 42 together. Although, there are no literal gaps between optical fibers 42 in the optical ribbon 40, there is a transition section C from an optical fiber 42 exiting the substrate 22 to the start of the output optical ribbon 40, where the optical fiber 42 is bent to a distance of substrate thickness to be next to the other optical fiber 42. Additionally, all groups of vertically positioned output optical 42 fibers are combined successively to form the remaining output optical ribbons 40.

In addition to vertically orientated output optical ribbons 40, horizontal output optical ribbons 40 are also required. As each group of vertically aligned optical fibers 42 exits the substrate 22, the output optical fibers 42 twist along the transition section C where they are first vertically orientated as they exit the substrate 22 and transition to horizontally orientated as they are grouped together to form the output optical ribbon 40.

In the present exemplary embodiment, the output section 28 of the optical circuit 20 has a plurality of output optical ribbons 40 extending therefrom. It should be understood that any form of termination can used in place of the output optical ribbons. This includes and is not limited to: optical fiber connectors, edge terminations, flexible circuitry and opto-electrical transceiver modules.

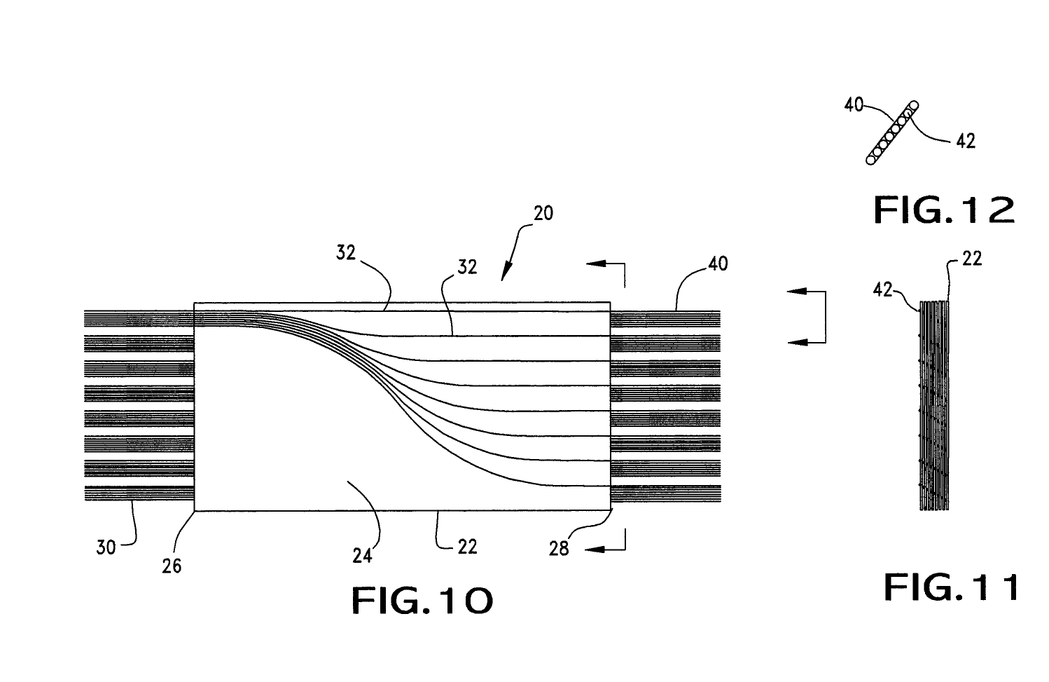

FIG. 10 shows an alternative embodiment to the optical circuit 20 described above, where similar structure is given the same reference number. The optical circuit 20, includes an 8×8 optical circuit system 10 identical to that described above but having output optical ribbons 40 extending from the output section 28 of the optical circuit 20 in a generally parallel orientation to the substrates 22. This is accomplished by having the output optical fibers 42 extending from the output section 28 of each of successively layered substrates 22, horizontally offset from one another. This process effectively groups the output optical fibers 42 in a generally flat relationship to the substrates 22.

Due to the fact that individual output optical fibers 42 extend from individual substrates 22, the output optical ribbons 40, although shown flat, extend from the output section 28 of the optical circuit 20 at an angle to the surface of the substrates 22.

FIGS. 11 and 12, show the output optical ribbons 40 at an angle to the substrate surface 24. As best shown in FIG. 13, as the output optical ribbons 40 extend further from the optical circuit 20, the optical ribbons 40 are transitioned flat. By utilizing this offset, there is no twisting of the output optical fibers 42 and the transition area C for the optical ribbons to get to the flat state is minimized.

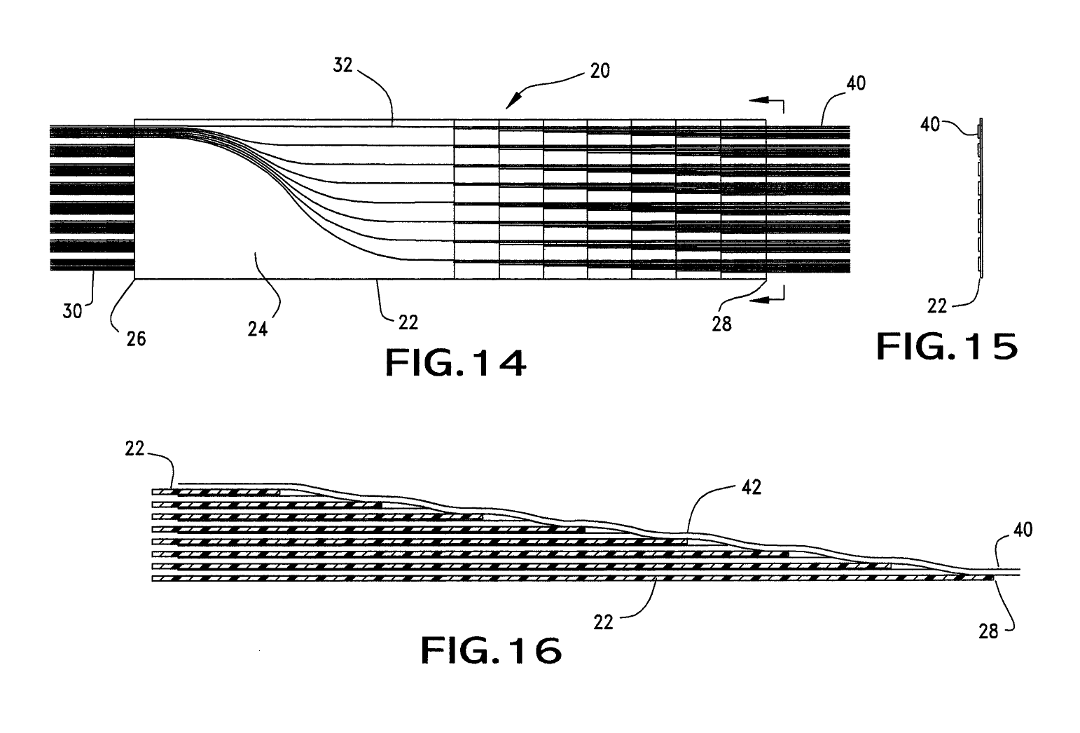

In an additional embodiment shown in FIG. 14, the substrates 22 used to make the optical circuit 20 have variable lengths. The substrates 22 are arranged from shortest to longest with appropriate optic fibers 32 positioned therebetween as previously described in the prior two embodiments. By having substrates 22 with increasing lengths, the optic fibers 32 disposed on the shorter substrate surfaces can be successively supported along their length by the remaining substrates until all of the optical fibers 32 exit the output section 28 of the substrate 22.

By producing the optical circuit in this manner, the transition section at the output portion of the optical circuit, as previously described is virtually eliminated and thereby minimizing the twisting of the output optical fibers. This allows the output optical fibers to be easily aligned and the conformal coating used to create the ribbon can be applied and cured without any unnecessary stress to the fibers. For illustrative purposes the distance each substrate 22 extends past the previous substrate is exaggerated, but in actuality are minimized to keep the overall length of the optical circuit 20 to a minimum. However, a variety of lengths may be used as designed or needed.

The output optical fibers 42 in this embodiment extend from the optical circuit 20 in a parallel orientation to the substrates 22, in other words the output optical ribbon 40 remains flat to the last or longest substrate as can be seen best in FIGS. 15 and 16.

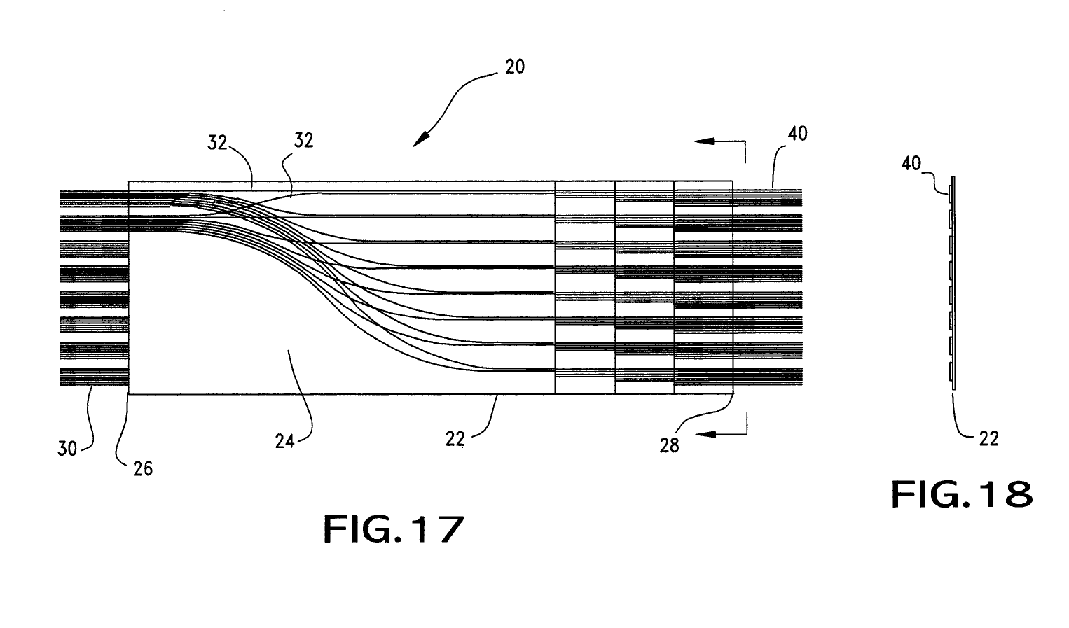

In a fourth embodiment, as best shown in FIG. 17, adjacent substrates 22 are incorporated into a single combined substrate and adjacent input optical fibers 32 are paired and disposed onto the combined single substrate. This allows the total number of substrates 22 to be reduced and to effect an overall reduction in the thickness of the optical circuit 20. As previously described the optic fibers 32 disposed on the shorter substrate surfaces can be successively supported along their length by the remaining substrates until all of the optical fibers 32 exit the output section 28 of the substrates 22. Additionally, the output optical fibers 42 in this embodiment extend from the optical circuit in a parallel orientation to the substrates 22 and remain flat to the last or longest substrate 22 as can be seen in FIGS. 18 and 19.

This embodiment depicts adjacent substrates and adjacent optical fibers as being combined in pairs, although other combinations may be used as well. For example, three adjacent fibers may be combined onto a single substrate, leaving a single optical fiber to be placed onto another substrate. This embodiment depicts only one possibility and is not limited to the configuration shown.

In practice, automating processes are used to construct these optical circuits. This process involves first adhering all of the optical fibers from one of the input optical ribbons to a first substrate in the predetermined orientation. The optical circuit is completed by successively stacking addition substrates on top of the previously completed layer, adhering the optical fibers from the next optical ribbon to that substrate and repeating this process until the optical circuit is complete. Although in this exemplary embodiment each layer is fashioned in serial order until the optical circuit is completed, it should be understood that alternative layering schemes may be employed. For example, the top and bottom layers have the optical fibers attached first, and then the intermediate layers are subsequently added. By use of this automated process for regrouping optical fibers within an optical circuit the overall size of the optical circuit is significantly reduced and all hand operations are eliminated thereby, minimizing the cost produce this optical circuit.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

We claim:

1. An optical fiber redistribution system, comprising:
an optical member having an input section and an output section, the optical member including at least one substrate;
said optical member further including at least one optical ribbon having at least one optical fiber, wherein at least one of the optical fibers extends from the input section of said optical member and least one optical fiber extends from the output section of said optical member; and
each individual said optical fiber of each of said optical ribbons is attached to a substrate in a pre-defined orientation between the input section of the said optical member and the output section of said optical member.

2. The redistribution system of claim 1, wherein each of the said optical ribbons are flat.

3. The redistribution system of claim 1, wherein the optical ribbon extending from the input section of the optical member is generally parallel to the substrates.

4. The redistribution system of claim 1, wherein each optical fiber of each optical ribbon is attached to a separate substrate.

5. The redistribution system of claim 1, wherein the optical fibers extending from the output section of the optical member are grouped in a ribbon.

6. The redistribution system of claim 5, wherein the optical ribbon extending from the output section of the optical member extends at a predetermined angle from the surface of the substrates.

7. The redistribution system of claim 5, wherein the optical ribbon extending from output section of the optical member includes a single optical fiber from each substrate.

8. The redistribution system of claim 1, wherein the substrates of the optical member are arranged in a vertical orientation.

9. The redistribution system of claim 1, wherein each substrate is of variable length.

10. The redistribution system of claim 9, wherein the substrates are arranged by increasing lengths.

11. The redistribution system of claim 10, wherein the optical fibers extending from a first substrate are supported by subsequent substrates.

12. The redistribution system of claim 9, wherein at least two adjacent substrates are combined into a single substrate.

13. The redistribution system of claim 12, wherein at least two adjacent optical fibers are grouped together and extend from the combined single substrate.

14. An optical fiber assembly comprising:
a plurality optical ribbons having multiple optical fibers contained therein;
an optical member having an input section and an output section wherein the optical fibers of the optical ribbons extend from the input section of the optical member, said optical member further including a plurality of substrates stacked in a vertical arrangement;
a plurality of second optical fibers extending from said output section of said optical member; and
wherein each individual said optical fibers of each of said optical ribbons is attached to a said substrate in a pre-defined orientation between said input section of the said optical member and said output section of said optical member in which each one of the second optical fibers extending from said output section of said optical member corresponds to one of said optical fibers extending from said input section of said optical member.

15. The optical fiber assembly of claim 14, wherein each substrate is of variable length.

16. The optical fiber assembly of claim 15, wherein the substrates are arranged by increasing lengths.

17. The optical fiber assembly of claim 16, wherein the optical fibers extending from a first substrate are supported by subsequent substrates.

18. The optical fiber assembly of claim 15, wherein at least two adjacent substrates are combined into a single substrate.

19. The optical fiber assembly of claim 18, wherein at least two adjacent optical fibers are grouped together and extend from the combined single substrate.

20. A method for providing an optical fiber assembly comprising:
providing at least one optical ribbon having a plurality of optical fibers contained therein,
providing an optical member having an input section and an output section including a plurality of substrates arranged in a vertical orientation,
providing a plurality of second optical fibers; and
attaching the optical fibers to the substrates wherein each individual said optical fibers of each of said optical ribbons is attached to a said substrate in a pre-defined orientation between said input section of the said optical member and said output section of said optical member in which each one of the second optical fibers extending from said output section of said optical member corresponds to one of said optical fibers extending from said input section of said optical member.

21. The method for providing an optical fiber assembly of claim 20 wherein the substrates are layered in a vertically stacked arrangement.

22. The method of providing an optical fiber assembly of claim 21 wherein the optical fibers are attached to the substrates in a predetemined order.
